(19) United States
(12) Patent Application Publication
(10) Pub. No.: US 2012/0274115 A1
(43) Pub. Date: Nov. 1, 2012

(54) SEAT INTEGRATED ENERGY MANAGEMENT DEVICE

(75) Inventors: Paul Michael SMITH, Davison, MI (US); Bradley Michael Glance, Dexter, MI (US); Joshua Jacob Clement, High Point, NC (US)

(73) Assignee: TK HOLDINGS INC.

(21) Appl. No.: 13/458,010

(22) Filed: Apr. 27, 2012

Related U.S. Application Data
(60) Provisional application No. 61/480,993, filed on Apr. 29, 2011.

(51) Int. Cl. B60N 2/20

(52) U.S. Cl. 297/354.1

(57) ABSTRACT

A frame for a vehicle seat generally includes a frame bottom and a generally vertical frame member. The Generally vertical frame member includes a lower end coupled to the frame bottom and also includes an upper end. The frame member includes a first weakened portion arranged between the upper end and the lower end. The weakened portion is configured to define a first bending region about which the upper end may rotate rearward upon application of a predetermined rearward load to the upper end.

### CROSS-REFERENCE TO RELATED PATENT APPLICATIONS

This application claims priority to and the benefit of U.S. Provisional Patent Application No. 61/480,993, filed Apr. 29, 2011, which is incorporated herein by reference in its entirety.

### BACKGROUND

The present disclosure relates generally to the field of motor vehicle seating and, in particular, regulation compliant seating. Various regulations, such as Federal Motor Vehicle Safety Standards, including FMVSS 222, impose various testing requirements on vehicle seats. However, compliance with these regulations adds cost and complexity to the design and manufacturing of seats. It would, therefore, be desirable to provide a seat that may reduce the complexity and/or cost associated with design and manufacturing for compliance with various regulations.

### SUMMARY

A frame for a vehicle seat generally includes a frame bottom and a generally vertical frame member. The Generally vertical frame member includes a lower end rigidly coupled to the frame bottom and also includes an upper end. The frame member includes a first weakened portion arranged between the upper end and the lower end. The weakened portion forms a first bending region about which the upper end may rotate or pivot rearward upon application of a predetermined rearward load to the upper end.

A frame for a vehicle seat generally includes a frame bottom and a vertical frame member. The vertical frame member includes a lower end rigidly coupled to the frame bottom and also includes an upper end. An insert is coupled to the vertical frame member between the lower end and the upper end. The vertical frame member includes at least one lower slot configured to define a lower bending region about which the upper end may rotate or pivot in a first direction. The lower slot and insert are cooperatively configured to plastically deform upon application of a predetermined load in the first direction to the upper end. The vertical frame member includes at least one upper slot configured to define an upper bending region about which the upper end may rotate or pivot in a second direction. The upper slot and insert are cooperatively configured to plastically deform upon application of a predetermined load in the second direction to the upper end.

A seat for a vehicle generally includes a frame bottom and at least one generally vertical member. The frame bottom is configured to define at least a portion of a seat bottom. The at least one generally vertical member is configured to define at least a portion of a seat back and includes a lower end and an upper end. The lower end of the generally vertical member is rigidly coupled to the frame bottom to prevent relative rotation therebetween. The vertical frame member is configured for the upper end to rotate or pivot forward relative to the lower end upon application of a predetermined forward load. The vertical frame member is configured to rotate rearward relative to the lower end upon application of a predetermined rearward load.

### BRIEF DESCRIPTION OF THE DRAWINGS

FIG. 1 is a perspective view of a bus that includes a seat assembly having an energy management device according to an exemplary embodiment.

FIG. 2 is a perspective view of a seat assembly having an energy management device according to an exemplary embodiment.

FIG. 3. is a perspective view of a seat frame having an energy management device according to an exemplary embodiment.

FIG. 4 is an exploded view of a seat having an energy management device according to an exemplary embodiment.

FIG. 5 is a side schematic view of a seat according to an exemplary embodiment.

FIG. 6 is a partial view of a seat frame having an energy management device according to an exemplary embodiment.

FIG. 7 is a partial perspective view of a seat frame having an energy management device according to another exemplary embodiment.

### DETAILED DESCRIPTION

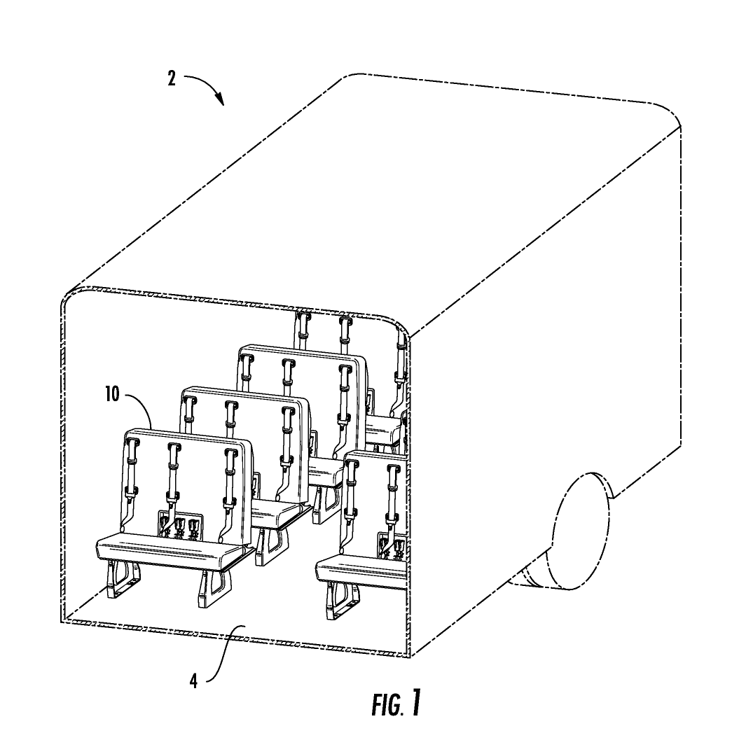

Referring generally to FIGS. 1 and 2, a bus 2 includes one or more seat assemblies 10 that are configured to absorb energy during a dynamic vehicle event, such as a crash or other sudden acceleration. Components of the seat assembly 10 work cooperatively, such that the seat assembly 10 may bend or deflect according to various Federal Motor Vehicle Safety Standards. More particularly, FMVSS 222 includes quasi-static testing that provides force, displacement, and energy absorption requirements for a sequence of forward forces applied to the rear of the seat back, forward forces applied through the seatbelts, and rearward forces applied to the front of the seat back. The seat assembly may instead or additionally be configured to conform with other standards, such as FMVSS 207 and 210, or may be configured according to other requirements, such as those for other jurisdictions or other applications.

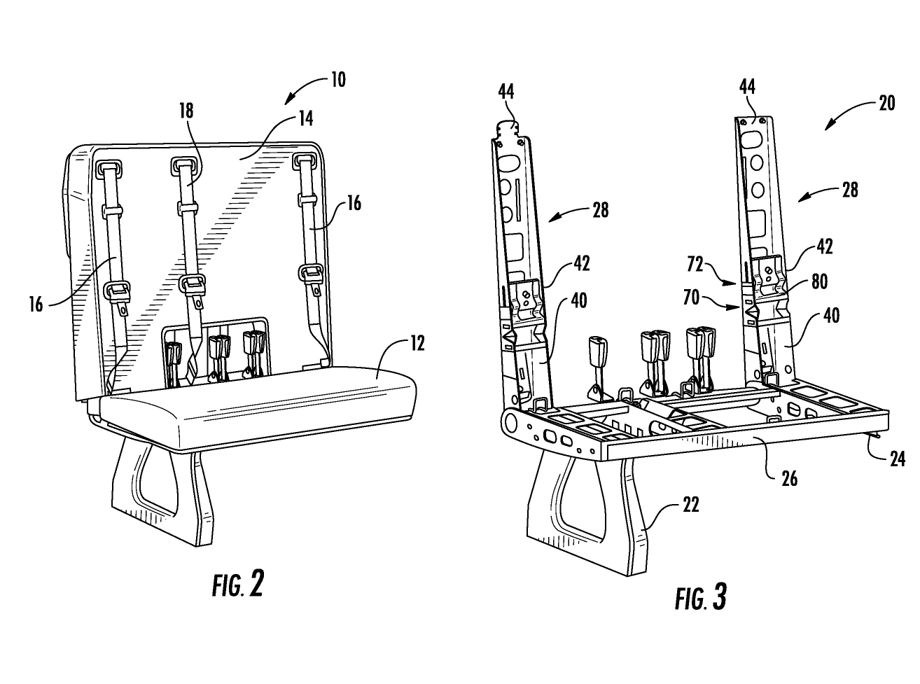

Referring to FIGS. 2-3, according to an exemplary embodiment, the seat assembly 10 includes a seat bottom 12, seat back 14, and seat belt assemblies 16, 18. A seat frame 20 provides structure for the seat assembly 10 and generally defines the shape or outlines of the seat bottom 12 and seat back 14. The seat belt assemblies 16, 18 are attached to the seat frame 20 and are configured to restrain a passenger in the seat assembly 10 during a dynamic vehicle event.

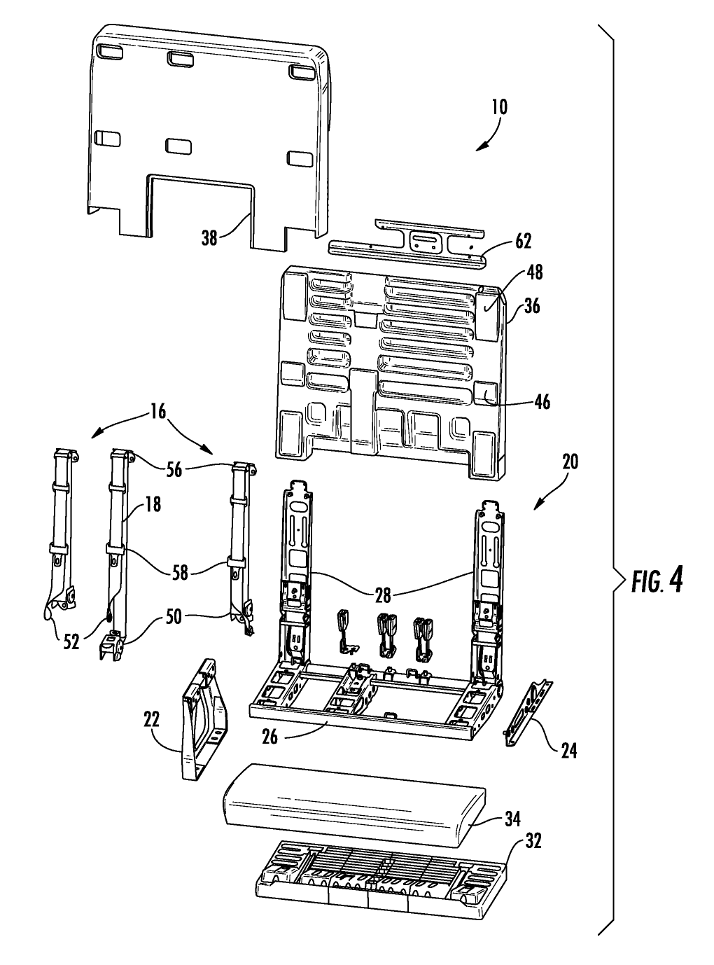

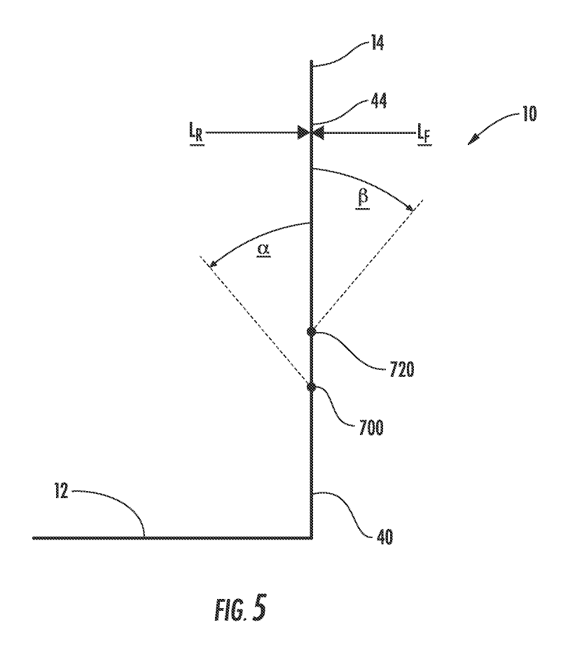

Referring to FIGS. 3-4, the frame 20 of the seat assembly 10 generally includes a pedestal 22 and/or mounting bracket 24, a frame bottom 26, and two generally vertical beams, posts, or towers 28. The pedestal 22, frame bottom 26, and beams 28 are each made of a rigid material (e.g., stamped steel) and are rigidly coupled together (e.g., by welding), so as to generally define or outline the seat bottom 12 and the seat back 14. According to other exemplary embodiments, frame components may be made from other materials (e.g., other metals, composites, plastics, combinations thereof, etc.), may be made according to other manufacturing methods (e.g., rolling, extrusions, molding, combinations thereof, etc.), may be coupled together in different manners (e.g., adhesives, fasteners, integral formation press- or tolerance-fit, combinations thereof, etc.), and the like.

The pedestal 22 and bracket 24 are configured to elevate the seat bottom 12 and seat back 14 above a bottom surface of the bus 2, such as a floor 4. The pedestal 22 and bracket 24 are each configured to also rigidly mount the seat assembly 10 to the mounting surface of the bus, such as the floor 4 or a wall. The pedestal 22 and bracket 24 may, for example, be coupled to the bus by any suitable method, which may include, for example, welding, fasteners, and releasable or irreleasable mechanisms, such as latches. According to other exemplary embodiments, the seat assembly 10 may be mounted to the bus in other manners including, for example, pedestals 22 being provided on both sides of the seat assembly 10, using other types of brackets, or any manner suitably adapted for a particular vehicle or application.

The frame bottom 26 and a bottom panel 32 cooperatively define the seat bottom 12, which is configured to support one or more passengers. The frame bottom 26 provides the structure for supporting the passengers, while the bottom panel 32 is coupled to the frame bottom 26 and provides a surface for passengers to be seated on. A cushion and/or covering 34 may also be provided over the bottom panel 32 as may be required or desired for passengers.

The frame bottom 26 generally includes front and rear sideward-extending members and left, right, and middle forward-extending members, which are coupled together to define a generally horizontal seat support. Each of the forward-extending members is coupled to both the front and rear members, such as by welding. The frame bottom 26 is disposed above and is rigidly coupled to the pedestal 22, such as by welding. According to other exemplary embodiments, the frame bottom 26 may include more or fewer members and may include other structural elements, such as cross-members, may be coupled to the pedestal 22 in different manners (e.g., fasteners, press- or tolerance-fit, integral formation, etc.), or any suitable combinations thereof.

The beams 28 and a back panel 36 cooperatively define the seat back 14, which is configured to support the backs of one or more passengers. The seat back 14 may also define passenger compartments in front of and behind the seat back 14. The beams 28 provide the structure for supporting the passengers, while the back panel 36 provides a surface against which the passengers may lean. A cushion and/or covering 38 may also be provided over the back panel 36 as may be required or desired for passengers.

The beams 28 are elongate, stamped steel members having a U-shaped cross section (i.e., having a closed end that interconnects legs that extend toward an open end). Lower ends 40 of the beams 28 are rigidly coupled to opposite ends of the frame bottom 26 in a manner that prevents relative rotation between lower ends 40 of the beams 28 and the frame bottom 26 (e.g., by welding). Middle portions 42 of the beams 28 are configured for energy absorption, as discussed in further detail below. Upper portions 44 of the beams 28 are configured to provide an upper harness point for the seat belt assemblies 16. According to other exemplary embodiments, the beams 28 may be made from different materials (e.g., other metals, composites, plastics, etc.), may be made according to different manufacturing processes (e.g., stamping, rolling, molding, etc.), may have different geometry (e.g., tubular, solid, different cross-section shape, varying geometry, etc.), and the like in suitable combinations for the seat assembly 10 described herein.

The back panel 36 is a unitary, blow molded plastic piece having receptacles disposed at opposite ends of a panel portion. Each of the receptacles is a generally vertical, hollow chamber having a bottom opening configured to receive one of the beams 28. Each receptacle also includes middle and upper openings 46, 48 through which seat belt webbing may pass. The receptacles have a shape and size that corresponds with the cross-sectional shape and size of the beams 28. The back panel 36 may also be coupled to the beams 28 at upper portions 44 of the beams 28 (e.g., on a rear side) with rivets or other fasteners, so as to prevent relative motion (e.g., sliding) between the back panel 36 and beams 28 and to impart structural rigidity between the beams 28 and back panel 36. The panel portion defines a generally flat forward surface against, which a passenger may lean or rest. The panel portion may also include various structural features, such as ribs, of varying size and shape to provide the back panel 36 with structural integrity independent of the beams 28 to support passengers.

The seat assembly 10 may include one or more seat belt assemblies 16, 18 configured to restrain passengers in the seat and to transfer energy from the passenger to the seat assembly 10. For example, the seat assembly 10 may include two outboard seat belt assemblies 16 and one inboard seat belt assembly 18. Each seat belt assembly 16, 18 forms a three-point harness configured to restrain a passenger in the seat assembly 10 during a dynamic vehicle event, such as a crash. According to other exemplary embodiments, the seat assembly 10 may include more or fewer seat belt assemblies 16 or 18 (see, e.g., FIG. 7 with two seatbelt assemblies 16).

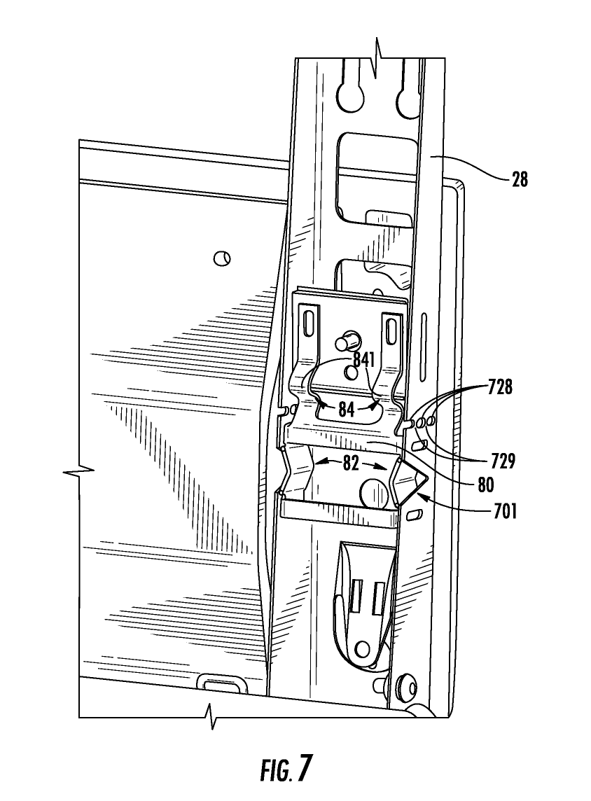

Referring to FIGS. 3-7, the beams 28 are configured to absorb energy during a dynamic vehicle event. More particularly, the beams 28 are configured to plastically deform in predetermined regions and in a controlled manner upon application of certain magnitudes of forces or combinations of forces applied directly to the seat back 14 or transferred through the seat belt assemblies. The forces may, for example, be those prescribed by the quasi-static testing requirements of FMVSS 222.

The middle portion 42 of each beam 28 includes one or more load allowance features or weakened portions 70, 72 and an energy absorbing (or management) device or insert 80, which work cooperatively to absorb energy and allow the beams 28 and seat back 14 to deform in a controlled manner.

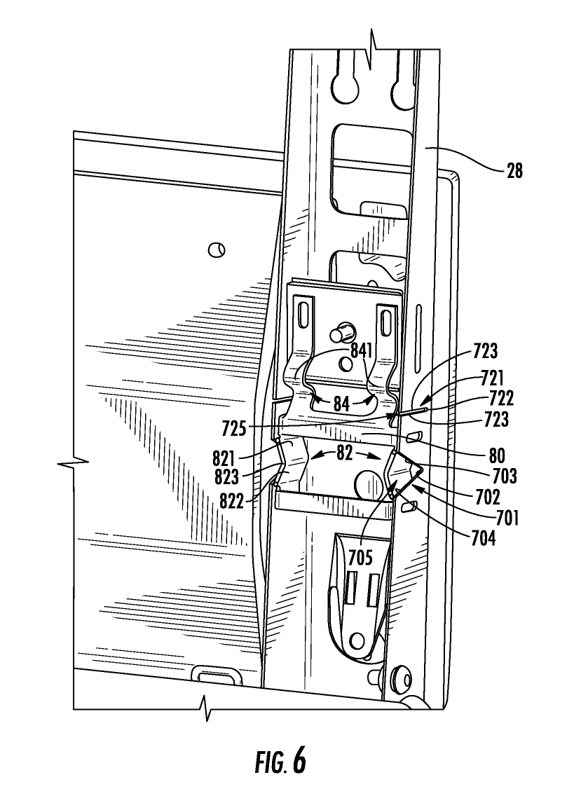

The weakened portions 70, 72 of the beams 28 are configured to facilitate the beams 28 to bending or hinging in a controlled manner. Further, the weakened portions 70, 72 may define a particular location or region at which the beams 28 bend and/or may limit rotational movement. For example, as shown in the schematic in FIG. 5, the beam 28 may be configured to bend, rotate or pivot in a forward direction a about a lower region 700 upon application of a forward load L_{F} and bend or rotate in a rearward direction β about a lower region 720 upon application of a rearward load L_{R}.

Two lower weakened portions 70 of the beam 28 are configured to enable forward rotation of the upper portions 44 of the beam 28 relative to the lower portions 40 of the beam. The two lower weakened portions 70 are arranged on opposite sides of the U-shaped channel, so as to define the lower bending region 700 of the beam 28. The lower weakened portions 70 may be generally V-shaped slots 701 that each include an apex 702 located generally toward the closed end of the U-shaped channel and two sides 703, 704 that extend away from the apex 702 toward an open end 705. When sufficient forward force is applied to an upper portion of the beam 28 (e.g., loads simulating seat belt load from a passenger of the seat assembly 10 and/or impact of the seat back 14 by a person or object situated behind the seat assembly 10), the beam 28 bends forward about a location proximate the apexes 702 of the slot 701 (e.g., the lower bending region 700 extending generally across the beam 28 between the apexes 702) until the two sides 703, 704 of the V-shaped slot 701 meet and prevent further rotation of the upper portion 44 of the beam 28. In this manner, the beam 28 plastically deforms to absorb at least a portion of the energy transferred from forward loads to the seat back 14. According to other exemplary embodiments, the lower weakened portions 70 may be configured in other manners (i.e., other than by providing the V-shaped slot 701) including, for example, weakening the beam in different manners (e.g., using thinner material, dimples, series of apertures, different material, combinations thereof, etc.), using different shaped features (e.g., having closed end, no apex, polygonal, round, slit, etc.), using features having different size or position (e.g., spaced closer to or further from the closed end of the U-shaped channel, different relative heights, etc.), providing a different number of features (e.g., more or fewer slots or other features one or both sides of the U-shaped channel, multiple features on one side of the U-shaped channel to cooperatively define one bend location, multiple features on one side to define multiple bend locations at different heights of the beam 28), and the like. Further, similar features may be employed and adapted for use with other generally vertical frame members having geometry other than a U-shaped cross-section (e.g., tubular, solid, varying geometry, etc.)

Further, two upper weakened portions 72 are configured to enable rearward rotation of the upper portions 44 of the beams 28 relative to lower portions 40. The two upper weakened portions 72 are arranged on opposite sides of the U-shaped channel, so as to define the upper bending region 720 of the beam 28. Each upper weakened portion 72 is a generally straight slot 721 having an apex 722 disposed generally toward the closed-end of the U-shaped channel and having sides 723, 724 that extend generally parallel away from the apex 723 toward an open end 725. When sufficient rearward force is applied to an upper portion 44 of the beam 28 (e.g., loads simulating a passenger of the seat assembly 10 impacting or pressing against the seat back 14), the beam 28 bends rearward about a location generally proximate the apexes 722 of the slot 721 (e.g., the upper bending region extending 720 across the U-shaped channel between the apexes 722). In this manner, the beam 28 plastically deforms to absorb at least a portion of the energy from rearward loads to the seat back 14.

Further, the upper weakened portions 72 may also be structured or otherwise configured to prevent forward rotation in the upper bending region (e.g., when a forward force is applied to the beam 28). For example, the slot 721 may have narrow gap between sides 723, 724, such that the sides 723, 724 engage each other after only minor rotation (e.g., before plastic deformation may occur). According to another exemplary embodiment as shown in FIG. 7, the upper weakened portions may include one or more perforations 728 having portions of continuous material 822 extending therebetween to transfer load from above to below the perforations 729.

According to other exemplary embodiments, upper weakened portions 72 may be configured in other manners and include other features as described above for the lower weakened portions 70 (e.g., different wakening, shape, location, number, etc.). Further, the weakened portions may be configured in other manners relative to each other including, for example, configuring the lower weakened portions 70 to enable rearward rotation of upper portions 44 of the beams 28 and configuring the upper weakened portions 72 to enable forward rotation.

The insert 80 is configured to provide structural rigidity to the beam 28 as well as absorb energy by plastically deforming when loads or combinations of loads of sufficient magnitude are applied to the seat back 14. The insert 80 may, for example, be a stamped, steel piece that is rigidly coupled to the tower, such as by welding, using fasteners, interference fit, combinations thereof, etc. The insert 80 is disposed within the U-shaped channel of the beam 28 and proximate the lower and upper weakened portions 70, 72. More particularly, the insert 80 includes various load controlling features or deformable portions 82, 84 that are disposed generally proximate the weakened portions 70, 72, or in other suitable locations, such that as the beam 28 bends about the weakened portions 70, 72, the deformable portions 82, 84 being configured to plastically deform in a controlled manner to absorb energy from loads applied to the seat back 14. According to other exemplary embodiments, the insert 80 may be configured in other manners consistent with the description herein and, for example, may be made from other materials, made by other manufacturing methods, be a multi-piece component, or be provided as multiple components.

Lower deformable portions 82 of the insert 80 are disposed generally proximate each of the lower weakened portions 70 of the beams 28 and are configured to fold or collapse to absorb energy when sufficient forward force is applied to the seat back 14. For example, each lower deformable portion 82 generally includes first and second planar portions 801, 802 divided by a crease or fold 803. The first and second planar portions 801, 802 extend in the same general direction as legs of the U-shaped channel of the beam 28 (i.e., between the closed and open ends of the U-shaped channel). The crease 803 is generally aligned with the weakened portion 70 of the beam 28. When sufficient forward force is applied to the seat back 14 to bend the beam 28, the insert 80 will fold at the crease 803 and collapse inwardly so as to absorb energy from the forward forces applied to the seat assembly 10. In this manner, in cooperation with the lowered weakened portions 70 of the beams 28, the lower deformable portions 82 of the insert 80 control the forward motion or rotation of the seat back 12 and may absorb predetermined amounts of energy during a forward loading event, such as FMVSS 222 testing. Further, the lower deformable portions 82 may allow a range of forward rotation of the upper portions 44 of the beams 28, such that sides 703, 704 of the slot 701 of the beam 28 reengage to prevent, restrict, or otherwise hinder continued forward rotation of the beam 28 or seat back 14.

Still further, the lower deformable portions 82 may be configured to limit the range of rearward rotation about the lower bending region (e.g., when a rearward force is applied to the beam 28 or seat back 14), for example, by having a predetermined length (i.e., in an unfolded or fully-extended position) or other suitable geometry, or otherwise have sufficient strength to limit rotation from application of a rearward load.

According to other exemplary embodiments, the lower deformable portions 82 may be configured in other manners including, for example, by having additional creases, having curves instead of creases, etc.

Upper deformable portions 84 of the insert 80 are disposed generally proximate the upper weakened portions 72 of the tower and are configured to unfold or elongate when sufficient rearward force is applied to the seat back 14. Each upper deformable portion 84 has a generally constant thickness and a curved, folded, or otherwise irregular profile. For example, each deformable portion 84 may include curves 841 (e.g., in an S-shaped profile) that are disposed generally adjacent or proximate the upper slots 70 of the beam 28. When sufficient rearward force is applied to the seat back 14, the curves 841 will unfold or straighten so as to absorb energy from the rearward forces applied to the seat back 14. In this manner, in cooperation with the upper weakened portions 72 of the beam 28, the upper deformable portions 84 control the rearward motion or rotation of the seat back 14 and may absorb predetermined amounts of energy during a rearward loading event. According to other exemplary embodiments, the upper deformable portions 84 may be configured in for energy absorption including, for example, different geometry (e.g., folds), different number of curves, etc.

According to other exemplary embodiments, the insert 80 may be configured in other manners including, for example, having a different orientation (e.g., having lower deformable portions 82 configured for rearward load absorption with upper deformable portions 84 configured for forward load absorption, arranging the insert 80 outside the U-shaped channel, etc.).

One advantage of the seat assembly 10 described herein is that the insert 80 may be modified according to the needs of a particular application of the seat assembly 10 with little or no corresponding change required for the beams 28. Economies of scale may then be achieved by utilizing a common beam 28 design across multiple seat assembly designs.

For example, the strength and energy absorbing characteristics of the insert 80 may be optimized for a particular use by selecting material types or thicknesses according to various material properties, such as modulus of elasticity, ultimate strength in tension and/or compression, cost, manufacturability, availability, etc. Geometry of the deformable portions 82, 84 may be adjusted, such as by changing the surface width of the deformable portions 82, 84 (i.e., more width provides more material, which provides added strength), or changing the shape (e.g., rounded profiles, creases, zig-zags, etc.). Orientation of the deformable portions 82, 84 may be adjusted relative to the weakened portions 70, 72 of the beams 28, such as by changing the planar orientation of the deformable portions 82, 84 relative to the U-shaped profile of the beams 28, or by changing the location of the deformable portions 82, 84 relative to the weakened portions 70, 72 (e.g., to change the moments about the hinge points to change force applied to the insert 80). Further, the insert 80 may be adapted for use with different types of seat assemblies, frames, or frame member, such as those having solid, tubular, varying, or other cross-sections.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the assemblies as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A frame for a vehicle seat having a seat bottom and seat back comprising:
a frame bottom for supporting the seat bottom; and
a generally vertical frame member for supporting the seat back, the frame member including a lower end coupled to the frame bottom and an upper end;
wherein the frame member includes a first weakened portion positioned between the upper end and the lower end, and wherein the frame member is configured to bend rearward about the weakened portion upon application of a predetermined rearward load to the upper end of the frame member.

2. The frame of claim 1, wherein the first weakened portion includes a slot in the vertical frame member.

3. The frame of claim 1, wherein the frame member is a U-shaped channel, the first weakened portion includes one slot on each side of the U-shaped channel.

4. The frame of claim 3, wherein each slot includes an open end and a closed end, wherein the frame member is configured to pivot rearward a region extending generally between the closed ends of the slots.

5. The frame of claim 1 further comprising an insert coupled to the frame member proximate the first weakened portion, wherein the frame member and the insert are configured to plastically deform upon application the predetermined rearward load.

6. The frame of claim 1, wherein the frame member includes a second weakened portion arranged between the upper end and the lower end, and wherein the frame member is configured to bend forward about the second weakened portion upon application of a predetermined forward load to the upper end of the frame member.

7. The frame of claim 6, wherein the first weakened portion includes a first slot in the vertical frame member; and wherein the second weakened portion includes a second slot in the vertical frame member.

8. The frame of claim 7, wherein the frame member includes an insert rigidly coupled thereto;
wherein the insert includes a first deformable portion positioned proximate the first slot, and a second deformable portion positioned proximate the second slot; and
wherein the first deformable portion is configured to deform upon application of the predetermined rearward load, and the second deformable portion is configured to deform upon application of the predetermined forward load.

9. A frame for a vehicle seat having a seat bottom and a seat back, comprising:
a frame bottom for supporting the seat bottom; and
a vertical frame member for supporting the seat back, the vertical frame member including a lower end coupled to the frame bottom and an upper end; and
an insert coupled to the vertical frame member between the lower end and the upper end;
wherein the vertical frame member includes at least one lower slot configured to define a lower bending region about which the upper end may rotate in a first direction, and the lower slot and the insert are cooperatively configured to plastically deform upon application of a first predetermined load in the first direction to the upper end; and
wherein the vertical frame member includes at least one upper slot configured to define an upper bending region about which the upper end may rotate in a second direction, and the upper slot and the insert are cooperatively configured to plastically deform upon application of a second predetermined load in the second direction to the upper end.

10. The frame of claim 9, wherein the vertical frame member is a U-shaped channel and includes two lower slots and two upper slots, each slot having an open end and an apex; and wherein the first bending region is defined generally between the apexes of the two lower slots, and the second bending region is defined generally between the apexes of the two upper slots.

11. The frame of claim 10, wherein the lower slots are V-shaped, each lower slot having upper and lower sides that extend at skewed angles from the apex to the open end; and wherein the upper slots are straight, each having upper and lower sides that extend generally parallel from the apex to the open end.

12. The frame of claim 9, wherein the insert includes a first deformable portion generally proximate the at least one lower slot, and a second deformable portion generally proximate the at least one upper slot.

13. The frame of claim 12, wherein the first deformable portion includes first and second planar portions divided by a crease, the first deformable portion configured to fold at the crease upon application of the first predetermined load; and
wherein the second deformable portion includes a curved portion, the curved portion configured to straighten upon application of the second predetermined load.

14. A seat for a vehicle comprising:
a frame bottom configured to define at least a portion a seat bottom; and
at least one generally vertical member configured to define at least a portion of a seat back, the at least one vertical member having a lower end and an upper end;
wherein the lower end of the at least one generally vertical member is coupled to the frame bottom to prevent relative rotation therebetween; and
wherein the at least one vertical frame member is configured for the upper end to rotate forward relative to the lower end upon application of a predetermined forward load, and is configured to rotate rearward relative to the lower end upon application of a predetermined rearward load.

15. The seat of claim 14, wherein the at least one generally vertical frame member includes a first weakened portion configured to enable forward rotation in a region of the first weakened portion upon application of the predetermined forward load, and includes a second weakened portion configured to enable rearward rotation in a region of the second weakened portion upon application of the predetermined rearward force.

16. The seat of claim 15, further comprising an insert rigidly coupled to the at least one vertical member; wherein the energy absorption device includes a first deformable portion that is positioned in the region of the first weakened portion and is configured to deform upon application of the predetermined forward load, and includes a second deformable portion that is positioned in the region of the second weakened portion and is configured to deform upon application the predetermined rearward load.

17. The seat of claim 16, comprising two vertical frame members, each having one energy absorbing device rigidly coupled thereto.
